(19) United States
(12) Patent Application Publication
(10) Pub. No.: US 2025/0272596 A1
(43) Pub. Date: Aug. 28, 2025

(54) REDUCING TEMPERATURE BASED PROCESSOR THROTTLING

(71) Applicant: International Business Machines Corporation, Armonk, NY (US)

(72) Inventors: Yuanchen Hu, Peekskill, NY (US); Philipp K Buchling Rego, Wappingers Falls, NY (US); Dustin Demetriou, Hyde Park, NY (US); Allan Cory VanDeventer, Poughkeepsie, NY (US)

(21) Appl. No.: 18/583,917

(22) Filed: Feb. 22, 2024

(51) Int. Cl. G06N 20/00; G06F 1/20

(52) U.S. Cl. CPC G06N 20/00; G06F 1/20

(57) ABSTRACT

A computer-implemented method to pre-emptively increase cooling in a processor to prevent temperature-based throttling. The method includes monitoring a set of parameters for a set of components on a server including a first temperature of a first processor processing a first workload. The method further includes predicting a future change in the first workload will cause a throttling event on the first processor. The method also includes initiating, in response to the predicting, an increased cooling to reduce the first temperature of the first processor, where the increased cooling is configured to prevent the throttling event.

### BACKGROUND

The present disclosure relates to server management, and, more specifically, to reducing temperature-based processor throttling in a multi-processor system.

Many computing systems require cooling systems to maintain processors and other computing components in predetermined temperature bands. The temperature is maintained by various components in a cooling system associated with the processing devices.

### SUMMARY

Disclosed is a computer-implemented method to pre-emptively increase cooling in a processor to prevent temperature-based throttling. The method includes monitoring a set of parameters for a set of components on a server including a first temperature of a first processor processing a first workload. The method further includes predicting a future change in the first workload will cause a throttling event on the first processor. The method also includes initiating, in response to the predicting, an increased cooling to reduce the first temperature of the first processor, where the increased cooling is configured to prevent the throttling event. Further aspects of the present disclosure are directed to computer program products containing functionality consistent with the method described above.

Further disclosed is a system comprising: a server comprising a processor; a throttling agent; a cooling system; and a computer-readable storage medium communicatively coupled to the processor and storing program instructions. The program instructions, when executed by the processor, are configured to cause the processor to: monitor a set of parameters for a set of components on the server including a first temperature of the first processor processing a first workload. The program instructions are further configured to cause the processor to predict a future change in the first workload will cause a throttling event on the first processor by the throttling agent. The program instructions are also configured to cause the processor to initiate, in response to the predicting, an increased cooling by the cooling system to reduce the first temperature of the first processor, wherein the increased cooling is configured to prevent the throttling event.

The present Summary is not intended to illustrate each aspect of, every implementation of, and/or every embodiment of the present disclosure.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 is a block diagram of a computing environment suitable for preemptively reducing processor temperature to prevent throttling, in accordance with some embodiments of the present disclosure.

FIG. 2 is a block diagram of a computing environment suitable for operation of a temperature manager and a load prediction manager in accordance with some embodiments of the present disclosure.

FIG. 3 is a flow chart of an example method to train a load prediction manager, in accordance with some embodiments of the present disclosure.

FIG. 4 is a flow chart of an example method to preemptively reduce processor temperature to prevent throttling, in accordance with some embodiments of the present disclosure.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as preemptive cooling to prevent throttling of block 195. In addition to block 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 195, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

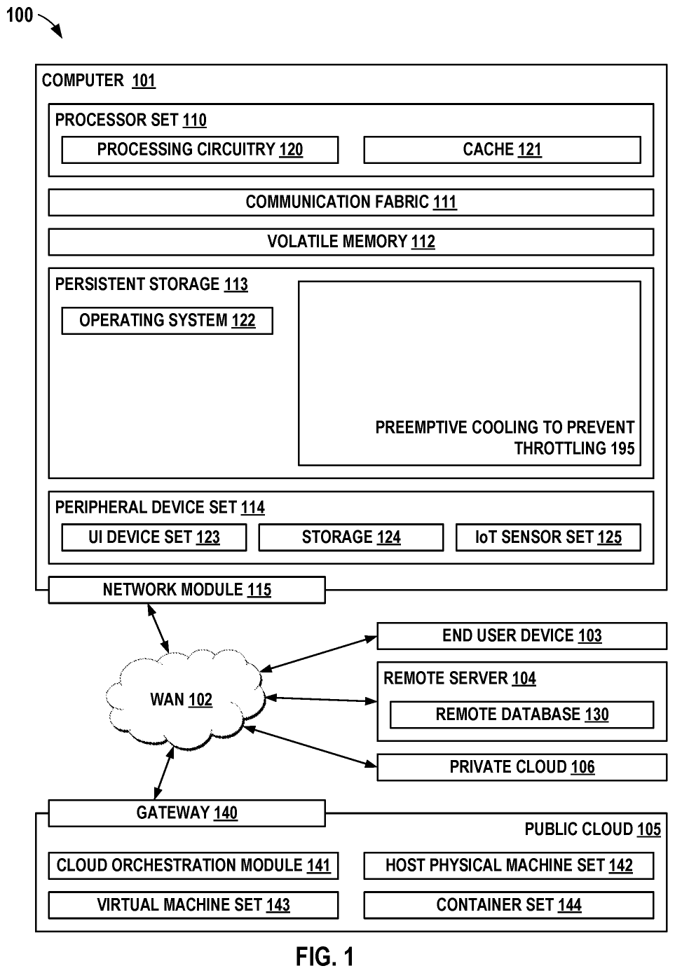

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 195 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The present disclosure relates to server management, and, more specifically, to reducing temperature-based processor throttling in multi-processor systems.

Many computing systems require external and/or internal cooling systems to prevent processors and other computing components from increasing in temperature to the point where they will become damaged. Ideally, the components are operated at or below predetermined temperature bands. The temperature is maintained by various components in a cooling system associated with the processing devices. Load changes in the computing devices can cause temperatures of the various components to change.

Components in the computing system can be damaged if they exceed design temperatures and/or may have reduced performance. Some embodiments prevent component damage by utilizing temperature based throttling. When a specific sensor determines the temperature of the relevant component exceeds the threshold, the system as a whole performs throttling actions. In some embodiments, the throttling can include reducing the amount of data processed by the overheated component. The throttling temporarily reduces the temperature, or at least prevents further increase. But the throttling can reduce the overall efficiency of the system as whole. Thus, reducing the amount of times a processor(s) is throttled can increase the overall efficiency of the system.

In some embodiments, computing systems utilize external cooling systems to maintain component temperatures within the prescribed operating limits. The external cooling can include built-in fans and/or external components such as fans, water cooling systems (e.g., pipes, pumps, heat exchangers, etc.) Running the components in the cooling systems increases the costs and energy use of running the computing systems. This can increase the overall cost of running, building, maintaining, and upgrading the computing system and/or reduce the overall efficiency of the system as a whole.

Modern computing systems, such as data centers try to balance maintaining component temperature at appropriate levels while trying to limit power expenditures needed by the cooling system fans and pumps. But excessive cooling increases energy and real costs without adding processing gains. The cooling system design and setpoints can be based on product design cycles starting with the high-level concept design. The design then moves to product testing via simulation and experimental testing before the product is released. The design and a certain level of technical margin are designed into a product to account for variation in parts and tolerances. Fan speeds and other cooling component specifications can be based on a generic testing result. But, because not all components can be tested widely, and because operation parameters and the magnitude, timing, and frequency of load changes vary from system to system and user to user, a base fan speed is often set that may not optimize energy efficiency. In some embodiments, cooling systems can adjust cooling parameters based on changes in workload. Fan speeds and other factors can be changed to alter the amount of cooling for various systems. However, the auto fan adjusting system could achieve fan power saving, but it is a reactive system. Or, said differently, because of the variance in operating conditions, backup methods, such as throttling, of protecting components are still needed to prevent system damage.

In some embodiments, throttling is a process of intentionally slowing and/or intentionally reducing the load of computing system. This has a negative impact on the computing performance of a device/system. The throttling can come in many forms. One example of throttling is to insert an instruction to pause for a predetermined period of time/cycles. The throttling gives the temperature of the throttled component time cool, or at least limit the rate of increase, with a goal of preventing overheating and damage to the components.

In order to reduce the amount of temperature-based throttling needed by a system, embodiments of the present disclosure predict load changes in a computing system and preemptively adjust one or more components in the cooling system to prevent throttling.

Embodiments of the present disclosure include a temperature manager and a load prediction manager. In some embodiments, the load prediction manager can predict future load changes on the servers that will cause temperatures to increase. If the predicted change is large enough, it can be predicted that the change will lead to an initiation of temperature based throttling. The predictions can be made by one or more learning models. In some embodiments, load prediction manager can gather and store operational data including the time and scenario around load changes and the associated temperature transients. This data can be used to train the learning models to predict future transients.

In some embodiments, the temperature manager preemptively increases the amount of cooling in response to the predicted throttling. Reducing the temperature prior to the load change will reduce the temperatures of the components. The temperature reduction can be configured to prevent throttling. If throttling is prevented, more processing work is done in the relatively high efficiency temperature bands. Thus, the efficiency of the system is increased over a system that required throttling, and the life of the components may be increased.

The aforementioned advantages are example advantages, and embodiments exist that can contain all, some, or none of the aforementioned advantages while remaining within the spirit and scope of the present disclosure.

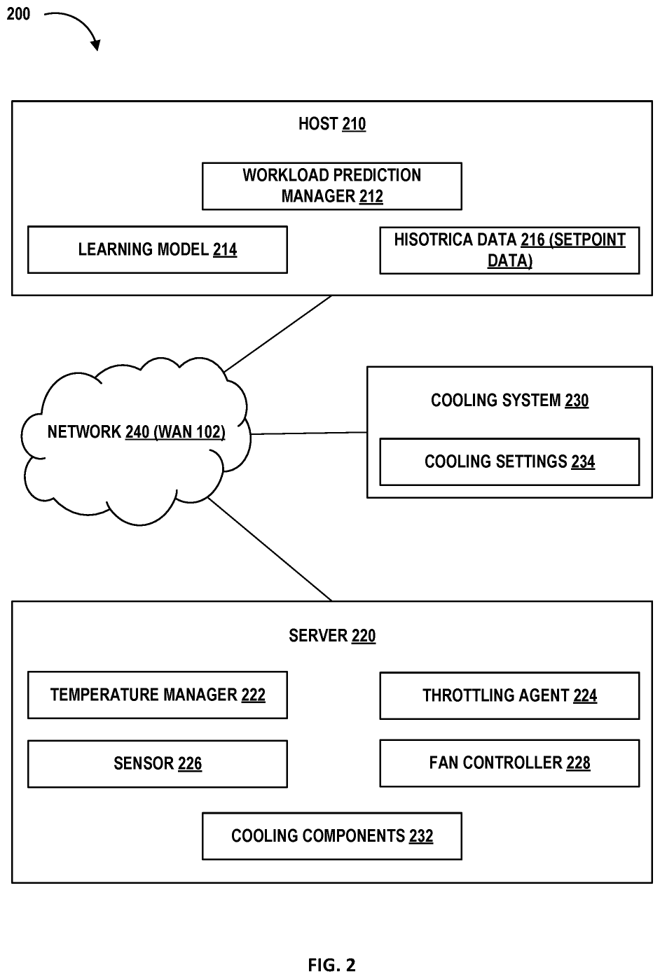

Referring now to various embodiments of the disclosure in more detail, FIG. 2 is a representation of a computing environment 200 that is capable of running a temperature manager and/or a load prediction manager accordance with one or more embodiments of the present disclosure. Many modifications to the depicted environment may be made by those skilled in the art without departing from the scope of the disclosure.

Computing environment 200 includes host 210, server 220, cooling system 230, and network 240. Network 240 can be, for example, a telecommunications network, a local area network (LAN), a wide area network (WAN), such as the Internet, or a combination of the three, and can include wired, wireless, or fiber optic connections. Network 240 may include one or more wired and/or wireless networks that are capable of receiving and transmitting data, voice, and/or video signals, including multimedia signals that include voice, data, and video information. In general, network 240 may be any combination of connections and protocols that will support communications between and among host 210, server 220, and other computing devices (not shown) within computing environment 200. In some embodiments, each of host 210, server 220, cooling system 230, and other devices not shown, may include one or more computer systems, such as computer 101 of FIG. 1.

Host 210 can be a standalone computing device, a management server, a web server, a mobile computing device, or any other electronic device or computing system capable of receiving, sending, and processing data. In other embodiments, host 210 can represent a server computing system utilizing multiple computers as a server system, such as in a cloud computing environment (e.g., cloud environment 105 or 106). In some embodiments, host 210 includes workload prediction manager 212, learning model 214, and historical data 216. In some embodiments, host 210, and/or any number of the subcomponents of host 210 can be incorporated into and/or combined into server 220 (or vice versa). However, they are shown as separate for discussion purposes.

Workload prediction manager 212 can be any combination of hardware and/or software configured to manage a workload assigned to server 220. In some embodiments, workload prediction manager 212 includes learning model 214 and/or historical data 316. However, they are shown as separate for discussion purposes.

In some embodiments, workload prediction manager 212 can manage all workloads that are sent to server 220. The management can include load balancing, security parameters, ensuring compliance with processing policies and the like. In some embodiments, workload prediction manager 212 monitors workload changes on server 220. The monitored parameters (or monitored workload) can include one or more of: processor temperature, cooling water temperature, fan speed, valve positions water pump speeds, humidity, indoor ambient temperature, outdoor ambient temperature, workload, date, time, client identifier, weather conditions, and workload. The indoor and/or outdoor ambient temperatures can be the heat sink temperatures for the air and/or water portions of the cooling system.

In some embodiments, workload prediction manager 212 detects and/or predicts a change in workload on server 220. The change in workload can lead to a temperature change of one or more components in server 220. In some embodiments, the predictions are based on the data previously stored for server 220. The stored data can be analyzed for trends and/or patterns. In some embodiments, the analysis is performed by learning model 214. In some embodiments, the prediction is based on the output of learning model 214. In some embodiments, the prediction includes one or more of a change in load on server 220 (or a particular core/card within server 220), a time of a change, a magnitude of the load change, and/or the associated effect/change on one or more monitored parameters/components (e.g., temperature). In some embodiments, workload prediction manager 212 sends the predictions to temperature manager 222. The prediction can include an instruction to alter one or more components in cooling system 230. The alteration can be configured to preemptively reduce the component temperature and thereby prevent throttling.

Learning model 214 can be any combination of hardware and/or software configured to predict a load change on server 220. In some embodiments, learning model 214 includes one or more learning models. The one or more learning models can be trained using data stored in historical data 216 and/or cooling system setting 234. In some embodiments, the one or more learning models can use some or all of the training inputs as inputs. In some embodiments, an output of learning model can include a time of a change, a magnitude of the load change, and/or the associated change in one or more monitored parameters (e.g., temperature). In some embodiments, the output can include a recommendation and/or instruction to alter one or more components in cooling system 230. The alteration can be configured to preemptively reduce the component temperature and thereby prevent throttling. In some embodiments, the different computing devices (e.g., host 210 and server 220) can be specially configured to train and/or execute the one or more learning models. In some embodiments, host 210 can be specially configured to train and/or execute the one or more learning models.

In some embodiments, learning model 214 may execute machine learning on data from the environment using one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR). In some embodiments, learning model 214 may execute machine learning using one or more of the following example techniques: principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), region-based convolution neural networks (RCNN), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

Historical data 216 can be any combination of hardware and/or software configured to store data for server 220 usage and cooling system 230 data. In some embodiments, the data is correlated between server 220 and cooling system 230. In some embodiments, historical data 216 can be used as training data for learning model 214.

Server 220 can be a standalone computing device, a management server, a web server, a mobile computing device, or any other electronic device or computing system capable of receiving, sending, and processing data. In other embodiments, server 220 can represent a server computing system utilizing multiple computers as a server system, such as in a cloud computing environment (e.g., cloud environment 105 or 106). In some embodiments, server 220 includes temperature manager 222, throttling agent 224, sensor 226, fan controller 228, and cooling components 232. In some embodiments, throttling agent 224, sensors 226, fan controller 228, and/or cooling components 232 can be included within temperature manager 222. However, they are shown as separate for discussion purposes.

In some embodiments, server 220 can include two or more distinct units. The units can be server cards, processors, and/or other similar components. In some embodiments, computing environment 200 includes one or more additional servers in addition to server 220. In some embodiments, server 220 is configured to maximize processing output while minimizing cooling costs. Said, differently, server 220 can be configured to use a minimum amount of cooling required to keep the components below a temperature threshold. The temperature threshold can be configured to prevent damage to the components and/or to maximize processing efficiency.

Temperature manager 222 can be any combination of hardware and/or software configured to maintain temperature of server 220 and/or individual components within server 220 below an operating threshold. In some embodiments, temperature manager 222 and workload prediction manager 212 can be combined. In some embodiments, temperature manager 222 can include throttling agent 224, sensor 226, fan controller 228, and/or cooling components 232. However, these are shown as separate for discussion purposes.

In some embodiments, temperature manager 222 is configured to maintain the temperature and other measured attributes of server 220 within operational limits. Temperature manager 222 can initiate actions to increase and/or decrease the amount of cooling and/or the amount of heat generating work server 220 and/or its subcomponents are performing. In some embodiments, temperature manager 222 monitors the various components in server 220. The monitoring can be based on information received from sensors 226.

In some embodiments, temperature manager 222 changes and/or recommends changes to cooling system 230. The changes can be based on the monitoring. For example, if the temperature of a processor increases above a threshold, additional cooling is needed. The additional cooling can be a throttling event/action by throttling agent 224 and/or increasing the amount of cooling by changing (or sending an instruction to change) a setting in cooling system 230. In some embodiments, temperature manager 222 is configured to limit the number of throttling actions. Each throttling action decreases the efficiency of the throttled component. So, limiting the number of throttling events and/or the time the throttling is occurring increases and/or maintains higher efficiency. If the temperature of the components decreases, such as below a low threshold, the processor still works adequately, however, extra energy is being used to operate unneeded cooling systems capacity. This increases the cost of operating server 220. In some embodiments, the ideal is to keep the temperature of the monitored components near the high temperature limit but with an operational band that can absorb small transients without initiating throttling. In some embodiments, the top of the band can be associated with the relevant threshold.

In some embodiments, temperature manager 222 can receive the predicted changes from workload prediction manager. In some embodiments, the predicted changes include a prediction that the workload will increase, where the increase in workload will cause the temperature of at least one component within server 220 to increase above the temperature threshold (e.g., cause a throttling event). The prediction can be received from host 210 and/or learning model 214. In some embodiments, temperature manager 222, in response to the received predictions, initiates additional cooling. The initiation can include altering a setting in cooling system 230, fan controller 228, and/or cooling component 232. The amount of cooling can be configured to prevent the predicted temperature increase, and thereby prevent the throttling event. The small cost of preemptive additional cooling has a small effect on efficiency/cost relative to the reduction in efficiency that would be caused by throttling. Thus, the predicting and preemptive cooling can increase the overall efficiency of operating server 220. In a scenario where there are multiple servers running in close proximity, the efficiency gained across the whole group of servers is compounded.

In some embodiments, temperature manager 222 sends operational data to workload prediction manager 212. The data received from sensors 226 can be sent to host 210 and/or learning model 214. In some embodiments, temperature manager 222 receives cooling system parameters. The cooling system parameters can be obtained from cooling system 230. The cooling system parameters show the status of all measurable components of the system. For example, fan speeds, water temperature, pump speeds, ambient temperature (indoor and outdoor), weather conditions (e.g., humidity and other factors that can affect heat exchange), and the like. In some embodiments, temperature manager 222 sends the cooling system parameters and the sensor data to historical data 216.

Throttling agent 224 can be any combination of hardware and/or software configured to initiate a throttling action (or throttling process, or throttling) in server 220. In some embodiments, the throttling is configured to limit and/or stop the workload of server 220 for a predetermined period of time. For example, the throttling agent 224 can add a wait action to the beginning of a processor's queue. The wait action will give time for the processor and/or other affected components to cool. In some embodiments, the throttling reduces a workload to a percentage (e.g., 80%) of the design workload. The workload will remain at a reduced percentage until the temperature reduces below a lower threshold/design threshold. The workload can increase to the design workload when temperature is lowered. However, if the temperature continues to increase to a higher temperature threshold, then the workload can be further reduced (e.g., 40% of design workload). As temperature reduces in response to the reduced workload, the workload can be increased at each step where it was reduced, and/or wait until the lower threshold is met and raise workload to 100%. In some embodiments, if a sever limit is exceeded, the processor can shut down or be reduced to 0% of the design workload. Various embodiments can use different setpoints, time periods, and/or load reduction values.

In some embodiments, the initiation of throttling can accompany a change in cooling system 230. Throttling can be re-initiated after the predetermined time, if the temperature is still above the threshold. In some embodiments, throttling is initiated in response to a command/instruction from temperature manager 222. In some embodiments, the throttling is initiated in response to one or more monitored parameters exceeding a setpoint. For example, if the temperature of a processor exceeds the predetermined setpoint for those components, that particular processor can be throttled.

In some embodiments, throttling agent 224 can initiate throttling for all of server 220 and/or for any combination of the subcomponents (e.g., processors, cards) within server 220.

Sensor 226 can be any combination of hardware and/or software configured to gather data within and/or surrounding server 220. Server 220 can include any number of sensors and any number of types of sensors. In some embodiments, the type of sensor includes one or more thermometers, thermocouples, heat detectors, moisture detectors, humidity detectors, ambient air detectors, and the like. The number and type of sensors can be configured to gather enough data to identify and monitor temperature and other operating characteristics of various components. In some embodiments, each sensor 226 sends the sensor data to temperature manager 222 and/or throttling agent 224.

In some embodiments, the various sensors can be placed in various locations around and within server 220. In some embodiments, data from sensors 226 can be sent to temperature manager 222 and/or load prediction manager 212. In some embodiments, the data from sensors 226 can be used to determine condition changes inside and outside of server 220.

Fan controller 228 can be any combination of hardware and/or software configured to alter parameters/speeds of components associated with cooling system 230 and/or cooling components 232. In some embodiments, fan controller 228 can be an interface between cooling system 230 and temperature manager 222. In some embodiments, fan controller 228 controls cooling components 232, or those incorporated into server 220.

Cooling system 230 can be any combination of hardware and/or software configured to provide cooling to server 220. In some embodiments, cooling system 230 includes one or more computing devices (e.g., computer 101). In some embodiments, cooling system 230 includes one or more cooling components and/or support components. These can include a series of pipes, fans, pumps, heat exchangers, and the like all interconnected to remove heat from server 220 and/or the facility in which server 220 is located. The various components can be manually and/or electronically initiated and/or altered. For example, fan speed can be changed by an electrical switch triggered by temperature manager 222. In some embodiments, cooling system 230 includes components installed inside and/or incorporated into/onto server 220. These are identified as cooling components 232. In some embodiments, cooling system 230 can be incorporated into server 220. In some embodiments, cooling system 230 includes cooling settings 234.

Cooling settings 234 can include setting and/or data for cooling system 230. In some embodiments, cooling settings 234 control the various parameters and/or components in cooling system 230. In some embodiments, cooling settings 234 can include provisions and/or different settings for ambient conditions in the vicinity. The ambient zone conditions include factors such as air temperature, elevation, water temperatures, pump size, and the like.

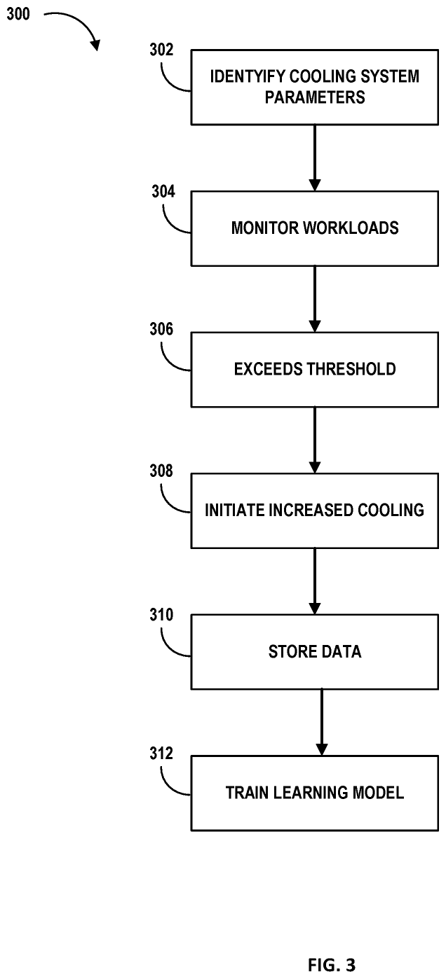

FIG. 3 is a flowchart of an example process 300 for training a load prediction manager that can be performed in a computing environment (e.g., computing environment 100 and/or computing environment 200). One or more of the advantages and improvements described above for preemptively cooling a processor to prevent throttling may be realized by process 300, consistent with various embodiments of the present disclosure.

Process 300 (or method 300) can be implemented by one or more processors, host 210, load prediction manager 212, learning model 214, historical data 216, server 220, temperature manager 222 throttling agent 224, sensor 226, fan controller 228, cooling system 230, cooling components 232, cooling settings 234, and/or a different combination of hardware and/or software. In various embodiments, the various operations of process 300 are performed by one or more of host 210, load prediction manager 212, learning model 214, historical data 216, server 220, temperature manager 222 throttling agent 224, sensor 226, fan controller 228, cooling system 230, cooling components 232, and/or cooling settings 234. For illustrative purposes, process 300 will be described as being performed by temperature manager 222.

At operation 302, temperature manager 222 identifies cooling systems parameters. In some embodiments, identification is obtaining the parameters from cooling system 330. In some embodiments, the parameters are obtained from workload predictions manager 212 and/or historical data 216. The parameters can include temperature thresholds/setpoints for server 220 as a whole and/or for each subcomponent within server 220. The parameters can further include actions to take based on exceeding the thresholds and returning below/above the thresholds. In some embodiments, the parameters include all data about the cooling system, such as fan speeds, air temperatures, water temperatures, and the like.

At operation 304, temperature manager 222 monitors workloads on a server (e.g., server 220). In some embodiments, the monitoring includes initiating and/or shifting loads within server 220 or between two or more servers. In some embodiments, the monitoring includes gathering data related to the processing of the workloads. The data can include user data (e.g., client, organization, etc.), time (e.g., time in day, day of week, months, holiday, etc.), workload amount, temperature of components, and/or cooling system parameters. In some embodiments, the monitored data is obtained by and/or from sensors 226, cooling system 230, system logs, and remote databases (e.g., weather).

At operation 306, temperature manager 222 determines a monitored parameter exceeds its associated threshold. In some embodiments, temperature of the server 220 components is/are the monitored parameter. In some embodiments, the determining includes a sensor reading that exceeds the associated threshold.

At operation 308, temperature manager 222 imitates additional cooling. In some embodiments, the additional cooling includes throttling the processing. The throttling can be initiated by throttling agent 224. In some embodiments, the additional cooling includes changing a cooling system parameter, such as fan speed as an example. However, changing the cooling system parameter is generally slower than throttling.

At operation 310, temperature manager 222 stores the monitored data. In some embodiments, the monitored data is sent to host 210. The monitored data can be stored in historical data 216. In some embodiments, the monitored data can be used as training data for learning model 214.

At operation 312, temperature manager 222 trains learning model 214. The training can be configured to predict workload changes on server 220. In some embodiments, the prediction can be configured to predict when the workload change will cause any monitored parameter to exceed its associated threshold and/or cause a throttling event. The prediction can also include a recommended change in the cooling system parameter. The recommended change will preemptively add enough cooling to limit any temperature transient from the predicted load change below the relevant threshold. In some embodiments, the training can include all the monitored data. For example, one user may have a large workload step increase on the weekends. The time and magnitude of the step increase, along with any temperature transients can be used as training data.

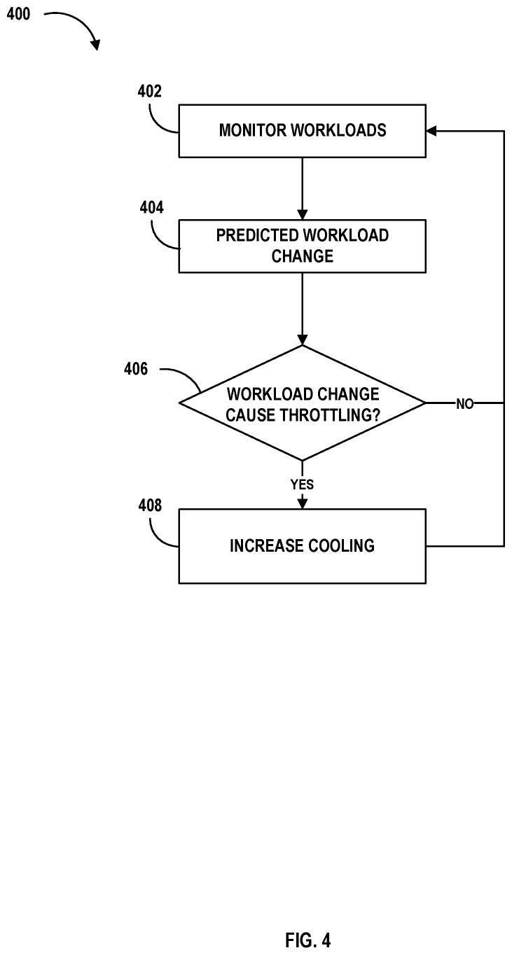

FIG. 4 is a flowchart of an example process 400 for preemptively cooling a processor to prevent throttling that can be performed in a computing environment (e.g., computing environment 100 and/or computing environment 200). One or more of the advantages and improvements described above for preemptively cooling a processor to prevent throttling may be realized by process 400, consistent with various embodiments of the present disclosure.

Process 400 (Or method 400) can be implemented by one or more processors, host 210, load prediction manager 212, learning model 214, historical data 216, server 220, temperature manager 222 throttling agent 224, sensor 226, fan controller 228, cooling system 230, cooling components 232, cooling settings 234, and/or a different combination of hardware and/or software. In various embodiments, the various operations of process 300 are performed by one or more of host 210, load prediction manager 212, learning model 214, historical data 216, server 220, temperature manager 222 throttling agent 224, sensor 226, fan controller 228, cooling system 230, cooling components 232, and/or cooling settings 234. For illustrative purposes, process 300 will be described as being performed by temperature manager 222.

At operation 402, temperature manager 222 monitors workload information for server 220. In some embodiments, operation 402 is consistent with operation 304 of process 300. In some embodiments, the monitoring is in response to the learning model 214.

At operation 404, temperature manager 222 predicts a workload change on server 220. In some embodiments, the prediction is made by workload prediction manager 212 and/or learning model 214. The prediction can be sent to temperature manager 222. In some embodiments, workload prediction manager 212 and/or learning model 214 are continuously predicting future workloads. The predictions can be for any time in the future, such as seconds to minutes, or days and months. In some embodiments, predictions include a predicted temperature transient and/or a magnitude of load change.

The predictions can be for server 220 as a whole or for any or all of the components within server 220. In some embodiments, workload prediction manager 212 makes a unique prediction for each user/organization. In some embodiments, workload prediction manager 212 makes predictions as a set interval. The interval can be based on historical data 216. For example, if a first user experiences frequent load changes, then the prediction can be made on a relatively short-term basis, such as daily or hourly. If the user's load changes are long term, for example, peaking around holidays, then prediction may be relatively less frequent, such as weekly or monthly.

At operation 406, temperature manager 222 determines if the predicted change will initiate throttling in server 220. In some embodiments, throttling is initiated if at least one parameter exceeds an associated threshold. In some embodiments, operation 406 includes temperature manager 222 receiving the prediction(s) from load prediction manager 212. In some embodiments, the determination is based on comparing the predicted workload and/or expected temperature/parameter change from based on the workload change to the threshold/setpoint associated with each parameter. If the predicted parameter meets and/or exceeds the threshold, then it is exceeding the threshold, and will be predicted to cause a throttling event.

If it is determined the predicted temperature will exceed the threshold (406:YES), then temperature manager 222 proceeds to operation 408. If it is determined the predicted temperature will not exceed the threshold (406:NO), then temperature manager 222 returns to operation 402.

At operation 408, temperature manager 222 increases cooling for the affected component. In some embodiments, increasing the cooling includes sending an instruction to cooling system 230, fan controller 228, and/or cooling system component 232. In some embodiments, the additional cooling changes one or more parameter of the cooling system parameters. The additional cooling is configured to reduce the temperature of the component prior to the load change and/or the temperature transient of the component. Thus, when the load change occurs with the associated temperature spike, throttling agent 224 is never activated. Or, said differently, the additional cooling prevents the actual temperature of the component from exceeding its associated threshold. The small extra cost of preemptive cooling has a minimal effect on the efficiency of operating server 220 compared to throttling without the preemptive cooling. The change can be an increase fan speed, increase water flow, and/or any change that will cause a reduction in the value of the monitored component, or a change that moved the value away from the associated threshold. Upon complete of operation 408, temperature manager 222 returns to operation 402.

Embodiments of the present disclosure increase the overall efficiency of operating one or more servers such as server 220. Load changes that lead to temperature spikes can cause damage to components and/or throttling that limit the life of the components and reduce the amount of work that is done by the processors. Predicting load changes and in response, preemptively cooling the components such that the resulting temperature transients stay below the throttling/damage threshold increase the overall processing capacity and thereby performance of the system as a whole. This may include increasing the life span of the components. Embodiments of the present disclosure allow servers to operate closer to the limits for longer periods of time increasing active processing while limiting excess cooling. More time can be spent operating in the design bands leading to better performance and longevity.

In one embodiment, as an example, the first throttling initiation (setpoint) temperature can be set at 80° Celsius. On a particular day, load prediction manager 212 predicts a large step increase in load at the end of the business day that will cause the temperature of the associated processors to increase from 75° C. to 85° Celsius. Before the close of business, temperature manager 222 can increase the cooling to reduce the temperature of the processors to about 65° Celsius. When the step increase in workload occurs, the max temperature of the processors remains below the threshold of 80° Celcius. A small increase in cooling for a short period of time before the increase prevented likely throttling (e.g., reduction of workload). Thus, the overall efficiency of the processors is greater than if the preemptive cooling did not occur.

### Computer Technology and Computer Readable Media

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
monitoring a set of parameters for a set of components on a server including a first temperature of a first processor processing a first workload;
predicting a future change in the first workload will cause a throttling event on the first processor; and
initiating, in response to the predicting, an increased cooling to reduce the first temperature of the first processor, wherein the increased cooling is configured to prevent the throttling event.

2. The computer-implemented method of claim 1, further comprising:
determining a first change in the first workload, wherein the first change initiates the throttling event, wherein the predicting is in response to the throttling event and is based on the throttling event.

3. The computer-implemented method of claim 2, further comprising:
storing the set of parameters, wherein the predicting is based on the storing set of parameters.

4. The computer-implemented method of claim 3, further comprising:
training a machine learning model to predict future workloads for the server, wherein the training is in response to the storing, and a set of training data comprises the stored set of parameters.

5. The computer-implemented method of claim 2, wherein the throttling reduces a design workload of the first processor.

6. The computer-implemented method of claim 3, wherein the throttling is initiated in response to the first temperature exceeding a first threshold.

7. The computer-implemented method of claim 6, wherein the increased cooling is provided by a cooling system integrated with the server and the cooling system is configured to maintain the first temperature in a first band, wherein a top of the first band is the first threshold.

8. The computer-implemented method of claim 7, wherein the increased cooling comprises increasing air flow to the first processor.

9. The computer-implemented method of claim 7, wherein the set of parameters comprises a configuration of the cooling system.

10. The computer-implemented method of claim 9, wherein the set of parameters comprise processor temperature, cooling water temperature, fan speed, valve positions water pump speeds, humidity, indoor ambient temperature, outdoor ambient temperature, workload, date, time, client identifier, weather conditions, and workload.

11. A system comprising:
a server comprising a processor;
a throttling agent;
a cooling system; and
a computer-readable storage medium communicatively coupled to the processor and storing program instructions which, when executed by the processor, are configured to cause the processor to:
monitor a set of parameters for a set of components on the server including a first temperature of the processor processing a first workload;
predict a future change in the first workload will cause a throttling event on the processor by the throttling agent; and
initiate, in response to the predicting, an increased cooling by the cooling system to reduce the first temperature of the processor, wherein the increased cooling is configured to prevent the throttling event.

12. The system of claim 11, wherein the program instructions are further configured to cause the processor to:
determine a first change in the first workload, wherein the first change initiates the throttling event, wherein the predicting is in response to the throttling event.

13. The system of claim 12, wherein the program instructions are further configured to cause the processor to:
store the set of parameters, wherein the predicting is based on the stored set of parameters.

14. The system of claim 13, wherein the program instructions are further configured to cause the processor to:
train a machine learning model to predict future workloads for the server, wherein the training is in response to the storing, and a set of training data comprises the stored set of parameters.

15. The system of claim 13, wherein the throttling event temporarily stops the processor from processing the first workload.

16. A computer program product, the computer program product comprising a computer readable storage medium having program instructions embodied therewith, the program instructions executable by a processing unit to cause the processing unit to:
monitor a set of parameters for a set of components on a server including a first temperature of a first processor processing a first workload;
predict a future change in the first workload will cause a throttling event on the first processor; and
initiate, in response to the prediction, an increased cooling to reduce the first temperature of the first processor, wherein the increased cooling is configured to prevent the throttling event.

17. The computer program product of claim 16, wherein the program instructions are further configured to cause the processing unit to:
determine a first change in the first workload, wherein the first change initiates the throttling event, wherein the prediction is in response to the throttling event.

18. The computer program product of claim 17, wherein the program instructions are further configured to cause the processing unit to:
store the set of parameters, wherein the predicting is based on the stored set of parameters.

19. The computer program product of claim 18, wherein the program instructions are further configured to cause the processing unit to:
train a machine learning model to predict future workloads for the server, wherein the training is in response to the storing, and a set of training data comprises the stored set of parameters.

20. The computer program product of claim 17, wherein the throttling temporarily stops the first processor from processing the first workload.
